(19) United States
(12) Patent Application Publication
(10) Pub. No.: US 2012/0218230 A1
(43) Pub. Date: Aug. 30, 2012

(54) INFRARED TOUCH SCREEN DEVICE AND MULTIPOINT LOCATING METHOD THEREOF

(75) Inventors: Lei Zhao, Shanghai (CN); Yuming Zhang, Shanghai (CN)

(73) Assignee: SHANGHAI JINGYAN ELECTRONIC TECHNOLOGY CO., LTD., Shanghai (CN)

(21) Appl. No.: 13/508,125

(22) PCT Filed: Nov. 2, 2010
(86) PCT No.: PCT/CN2010/078314

§ 371 Date: May 4, 2012

(30) Foreign Application Priority Data
Nov. 5, 2009 (CN) 200910198341.3

(51) Int. Cl. G06F 3/042

(52) U.S. Cl. 345/175

(57) ABSTRACT

An infrared touch screen device and a multi-touch locating method thereof are provided. On the touch screen, large angle infrared emitting elements and infrared receiving element are used to realize the axis scanning of multi-angle by an optimized sampling and processing circuit. After the data processing of removing ambient light, normalization and so on for original data of the axis scanning, the logic axis touch information is generated, and a luminance map of the current frame is generated according to the information. Multiple valid touch regions are recognized by contrast with a theoretical touch luminance map. Then a tracing algorithm of image is used, and a multi-touch event is outputted finally. The touch device is simple, reliable and accurate and has wide range application.

### CROSS REFERENCE TO RELATED APPLICATIONS

The present application claims priority to Chinese Patent Application No. 200910198341.3, entitled “INFRARED TOUCH SCREEN DEVICE AND MULTIPOINT LOCATING METHOD THEREOF”, and filed on Nov. 5, 2009, the entire disclosure of which is incorporated herein by reference.

### FIELD OF THE INVENTION

The present invention generally relates to the infrared touch screen technology, and more particularly, to an infrared touch screen device which is capable of distinguishing multiple touch points and operating the multiple points at the same time, and a method for positioning multiple touch points thereof.

### BACKGROUND OF THE INVENTION

Infrared touch screen devices have been developed rapidly as an interactive device because of simple production process and low production cost. A fundamental structure of an infrared touch screen device includes a plurality of pairs of infrared transmission and reception units arranged along the edges of a display in a certain order. These transmission and reception units constitute infrared transmission-reception pairs in one-to-one correspondence and are arranged in a form of transmission-reception arrays perpendicular to each other along the edges of the display. In practice, each infrared transmission-reception pair is switched on in a certain order under control of a computer system. By detecting an infrared beam interruption in a transmission-reception pair, a touch event can be determined. More detailed principles can be referred to U.S. Pat. No. 5,162,783 and other Chinese patents.

In a conventional infrared touch screen system, infrared beams form a grid structure superposed upon a display. A position coordinates the touch event can be determined according to a position of a grid node where the touch event happens. In this way, the infrared touch-screen system can only detect one set of position coordinates in a preset time period, which means the infrared touch-screen system can work well when there is only one touch event happening, however, if there are multiple touch events happening in a preset time period, the system would make an error with providing wrong position coordinates deviating from the actual position.

For the above reasons, the conventional Infrared touch screen system fails to work in situations where a multiple touch events are required. Currently, there is already provided a solution to identify multiple touch points, such as by detecting a sequence of the touch events combined with a tracking algorithm. However, for multiple touch points moving simultaneously, or multiple touch points moving in intersection way, it happens frequently in practice that the position is misidentified, resulting in a poor practical effect.

Chinese patent No. CN200710100010.2 discloses a method by utilizing an off-axis scanning, that is, a skew axis scanning to get rid of false touch points, in which different axes are processed by different means, resulting in a complicated logic, and a complicated mathematical model especially with the increasing of the number of the touch points, which still results in poor practical effect.

In view of the above-mentioned facts, there is a need to provide a method and an infrared touch screen device thereof, which is practical, independent of the number of touch points and fully supported by a mathematical model.

### BRIEF SUMMARY OF THE INVENTION

Embodiments of the present disclosure provide a method and an infrared touch screen device using the method, which is practical, independent of the number of touch points and fully supported by a mathematical model.

Compared with a circuit structure of a conventional infrared touch-screen device, a circuit structure of the infrared touch screen device in the embodiments of the present disclosure has the following characteristics and features.

1. Differently from a screen supporting one touch point with pursuing focusing energy, each of the infrared transmission units utilized has a greater transmission angle range and each of the infrared reception units utilized has a greater reception angle range.

2. In the infrared touching screen device, signals sent from each infrared transmission unit can be detected by multiple infrared reception units within a transmission angle range of the infrared transmission unit; and similarly, each infrared reception unit can detect signals sent from multiple infrared transmission units in a reception angle range of the infrared reception unit.

3. Theoretically, all signals within the reception angle range of the infrared reception unit can be collected. In practice, in order to reduce processing time and promote a frame rate, only signals in typical angles are collected and processed.

4. Data of infrared transmission-reception pairs which have the connection lines extending along a same scanning angle is defined as a set of axis scanning data. Data of the directly opposite transmission-reception unit pair is a special set of axis scanning data in a special scanning angle, which is called as a zero degree angle scanning data or direct axis scanning data.

5. For better improving users' experiences, infrared touch screen devices are required to have a specific frame rate, typically 50 frames per second in the field. However, in order to perform axis scanning in multiple angles, the number of the transmission-reception unit pairs is several times or dozens of times as that of the screen only supporting one touch point. Therefore, sampling and processing time of each transmission-reception pair is reduced. In order to speed up sampling processes, multiple analog signal processing devices are adopted for sampling signals in parallel and multiple analog-digital converter devices are adopted for processing the signals in parallel or serial. In addition, the infrared transmission units may be wholly supplied with electricity at the same time, or the infrared transmission units are divided into different groups and the different groups of the infrared transmission units is supplied with electricity in turn.

6. In order to avoid a low scanning speed caused by frequent transmission of addressing request data and a complex switching Logic of the transmission or reception, a programmable device (such as FPGA, CPLD) is used to preset switching logic to replace addressing request with simple combination of clock signals and enabling signals.

Corresponding to circuits changes described above, a method for positioning multiple touch points is described hereinafter.

For convenience's sake, firstly, a conception of brightness is defined herein. Brightness is a logic conception, whose value is a number of scanning axes which pass through a pixel point. A practical brightness map indicates practical numbers of axis scanning of all pixel points on the current frames. A theoretical brightness touch map indicates theoretical numbers of axes passing through a pixel if the pixel is in a pressed state. If the practical numbers of scanning axes passing through a pixel point is equal to the theoretical number of scanning axes passing through the pixel in a pressed state, the pixel point is corresponding to a touch region where there is a touch event happening.

The method for positioning multiple touch points includes the following steps:

Step 1, predetermining scanning axes and scanning angles corresponding to the scanning axes, and initializing hardware of an infrared touch screen device;

Step 2, creating an image which has a same resolution in magnitude as that of a touch screen, and initializing brightness of each pixel point as 0;

Step 3, successively performing axis scanning in different angles in a scanning period, obtaining logical touch data groups of the axes by data processing to the axis scanning data, such as substraction of environmental lights and normalization. For example, the logical touch data group may have following format:

a starting position 1, a width 1, a starting position 2 . . . , a width 2 starting position N, a width N; or

a starting position 1, an ending position 1, a starting position 2, an ending position 2 . . . , a starting position N, an ending position N; or other similar formats indicating these logical touch data;

Step 4, finding parallelogram axis scanning regions according to logical touch data groups (including the axis angles, starting positions, and widths) obtained in the step 3 in the image created in the step 2, and forming a practical brightness map after successively processing all logical touch data groups, wherein at each time after finding a parallelogram axis scanning region, brightness of pixel points in the parallelogram axis scanning region is increased by 1;

Step 5, calculating theoretical brightness of each pixel when is in touched state to create a theoretical brightness map;

Step 6, comparing the practical brightness map with theoretical brightness map to determine touch regions, and obtaining blob information of touch regions in combination of image processing method; and

Step 7, continuing to perform step 2 to step 6 to obtain different blob information at different frame, and determining multiple touch events in combination of image tracking algorithm, such as a “DOWN” event, an “LIP” event, a “MOVE” event.

It is noted that, the above description illustrates fundamental steps. It is appreciated by those of ordinary skill in the art that the sequence of illustrated steps may be modified, reduced or augmented and the calculation method may be changed, such as adopting a summation instead of a subtraction, in order to optimize processes. Besides, in order to speed up processing, the practical brightness map and the theoretical brightness map may be conformally scaled down. These modifications maybe employed without departing from the spirit and scope of the present invention.

Compared with the conventional infrared multiple touch points solution, the embodiments of the present disclosure has the following advantages.

1. The embodiments of the present disclosure provide a universal method for positioning multiple touch points, and number of the multiple touch points is not limited.

2. The present disclosure provides a simple method to process all axes scanning information with simple logic, facilitating a speed up in hardware.

3. With the present method, it is easy, accurate and reliable to calculate the touch point position.

4. In the present disclosure, the brightness map designated is a logic conception. With this conception, the infrared touch screen is taken as a camera for obtaining a gray image, and then an identification algorithm can be employed to process the multiple touch points data, which provides an important breakthrough in the infrared touch screen technology field.

### BRIEF DESCRIPTION OF THE DRAWINGS

FIG. 1 is a schematic view for illustrating that infrared beams sent from an infrared transmission unit are detected by multiple infrared reception units according to an embodiment of the present disclosure;

FIG. 2 is a schematic view for illustrating that an infrared reception unit receives infrared beams sent from multiple infrared transmission units according to an embodiment of the present disclosure;

FIG. 3 is a schematic view of a circuit for illustrating a method for speeding up processing according to an embodiment of the present disclosure;

FIG. 4 is a schematic view of three touch points according to an embodiment of the present disclosure;

FIG. 5 is a schematic view of a theoretical brightness map of the three touch points shown in FIG. 4 according to an embodiment of the present disclosure;

FIG. 6 is a schematic view of an initial brightness map according to an embodiment of the present disclosure;

FIG. 7 is a schematic view of an updated brightness according to an axis scanning logical touch data group according to an embodiment of the present disclosure;

FIG. 8 is a schematic view of a final practical brightness map after all logical touch data groups are processed according to the embodiment in FIG. 4;

FIG. 9 is a schematic view of touch regions obtained by comparing FIG. 5 with FIG. 8;

FIG. 10 is a schematic view of touch regions obtained by considering infrared transmission-reception unit pairs arranged along both a horizontal angle X and a vertical angle Y according to an embodiment of the present disclosure;

FIG. 11 is a schematic view of blob information after a frame data is processed according to an embodiment of the present disclosure; and

FIG. 12 is a schematic view illustrating a method for determining a touch event, a move event, an up event, and a down event according to an embodiment of the present disclosure.

### DETAILED DESCRIPTION OF THE INVENTION

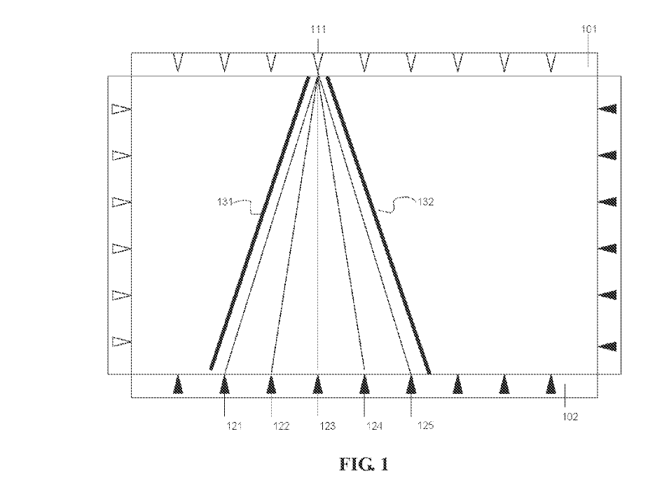

FIG. 1 is a schematic view for illustrating that infrared beams sent from an infrared transmission unit are detected by multiple infrared reception units according to an embodiment of the present disclosure. Referring to FIG. 1, an infrared touch screen device includes a transmission circuit board 101 equipped with infrared transmission units, and a reception circuit board 102 equipped with infrared reception units. An infrared transmission unit 111 is arranged on the transmission circuit board 101, and infrared reception units 121, 122, 123, 124 and 125 are arranged on the reception circuit board 102. Lines 131 and 132 show a transmission angle range of the infrared transmission unit 111. As shown in FIG. 1, infrared beams sent from the infrared transmission unit 111 can be detected by the infrared reception units 121, 122, 121 and 125.

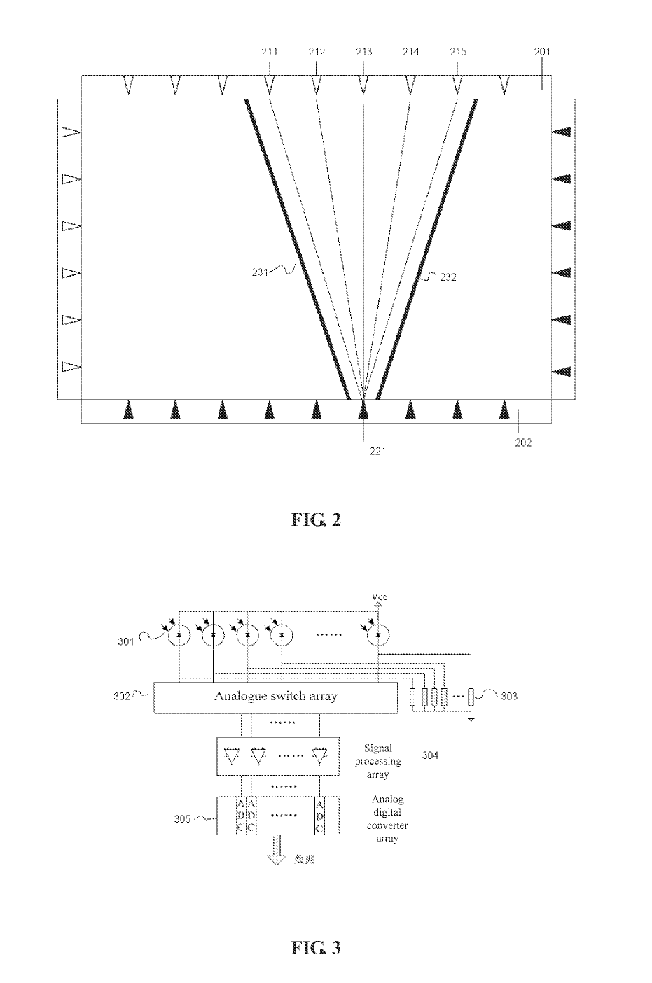

FIG. 2 is a schematic view for illustrating that an infrared reception unit receives infrared beams sent from multiple infrared transmission units according to an embodiment of the present disclosure. Referring to FIG. 2, a transmission circuit board 201 is equipped with infrared transmission units, a reception circuit board 202 is equipped with infrared reception units, an infrared reception unit 221 is arranged on reception circuit board 202, and infrared transmission units 211, 212, 213, 214 and 215 are arranged on the transmission circuit board 201. Lines 231 and 232 show a reception range of the infrared reception unit 221. As shown in FIG. 2, the infrared beams sent from the infrared transmission units 211, 212, 213, 214 and 215 can be received by the infrared reception unit 221.

The transmission angle range shown in FIG. 1 or the reception angle range shown in FIG. 2 may refer to a transmission angle of the infrared transmission unit or a reception angle of the infrared reception unit in a product manual. In practical operation, the transmission angle range or the reception angle range should be determined according to signal-to-noise performance for distinguishing transmitting signals from interfering signals of a practical processing circuit. In other words, the transmission angle range or the reception angle range in practical operation may be greater than that specified in the product manual. Besides, the transmission angle range or the reception angle range in practical operation is closely related to the means how the infrared transmission units or the infrared reception units are mounted.

FIG. 3 is a schematic view of a circuit for illustrating a method for speeding up processing according to an embodiment of the present disclosure. Referring to FIG. 3, an end of an infrared reception unit 301 is connected to VCC, the other end is connected to one input end of an analogue switch array 302 and an end of a sampling resistance 303. The other end of the sampling resistance 303 is connected to ground. An optimal performance may be achieved by configuring an independent signal sampling circuit and an independent processing circuit for each of the infrared reception units, however, considering cost-effectiveness, an analog switch array 302 is employed to reduce circuits for sampling and processing signals of multiple infrared reception units in parallel. In addition, an analog digital converter array 305 is adopted to speed up data processing with multiple sampling chips, a single sampling chip pipeline, or a combination thereof.

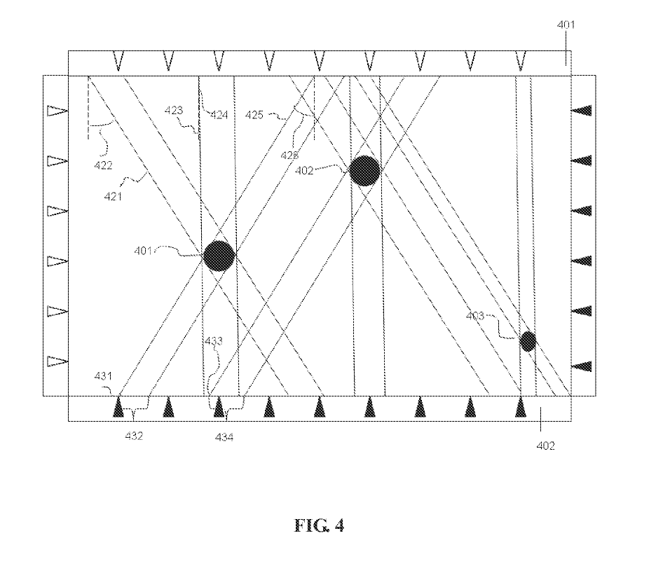

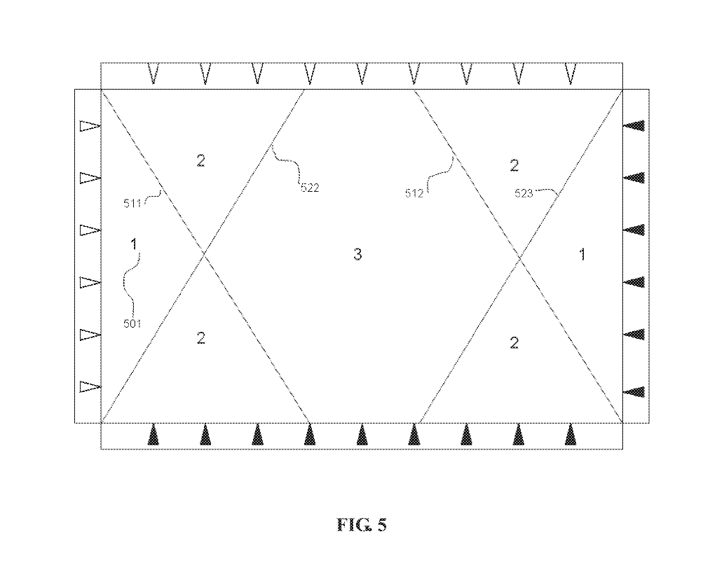

A method for positioning multiple touch points is described as follows in conjunction with FIG. 4 to FIG. 8.

FIG. 4 is a schematic view of three touch points according to an embodiment of the present disclosure. Referring to FIG. 4, there are three touch points 401, 402 and 403 among which the touch point 403 is smaller than the touch points 401 and 402, and there are three scanning axes 421, 423 and 425 for exemplary illustration. FIG. 1 and FIG. 2 show scanning range between lower and upper limits, however, in practice, only a plurality of axes in specific angles are selected to reduce processing time and improve frame rate. For example, in FIG. 4, three scanning axes 421, 423 and 425 are used. The three scanning axes 421, 423 and 425 respectively have three scanning angles 422, 424, and 426. Symbols 431, 432, 433 and 434 represent, exemplarily, logical touch data of the scanning axis 425. Specifically, 431 represents a starting position of a first touch point, the parameter 432 represents a width of the first touch point, the parameter 433 represents a starting position of a second touch point, and the parameter 434 represents a width of the second touch point. Logicalization of the scanning axes 421 and 423 is defined the same as that of the scanning axis 425. There are three scanning axes passing through the touch points 401 and 402, and there are two scanning axes passing through the touch point 403, because the touch point 403 is not in an axis scanning region of the scanning axis 425.

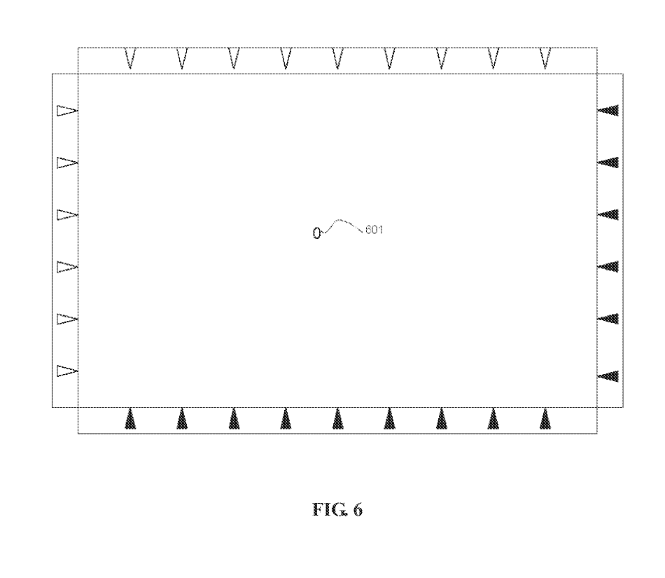

FIG. 5 is a schematic view of a theoretical brightness map of the three touch points shown in FIG. 4 according to an embodiment of the present disclosure, Axis scanning regions of the scan axes 421, 423, and 425 are shown in FIG. 5. Referring to FIG. 5 a region between two lines 511 and 512 is an axis scanning region of the scanning axis 421, and a region between two lines 521 and 522 is an axis scanning region of the scanning axis 425. The scanning axis 423 is a direct scanning axis, whose axis scanning region nay cover the whole region of the touch screen, According to overlap of the axis scanning regions, theoretical brightness in different regions can be calculated and labeled with symbols such as 501, and then a theoretical brightness map for showing theoretical brightness in different regions when is touched is achieved.

Following describes how to obtain a practical frame brightness map according to the logical touch data of the scanning axes.

FIG. 6 is a schematic view of an initial brightness reap according to an embodiment of the present disclosure.

Referring to FIG. 6, before the logical touch data is processed, brightness of each pixel point in a practical brightness map is initialized as 0, as shown with a symbol 601.

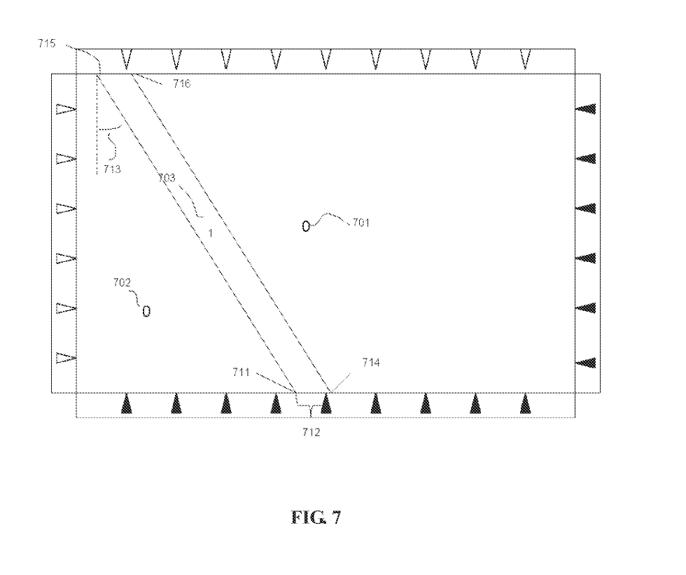

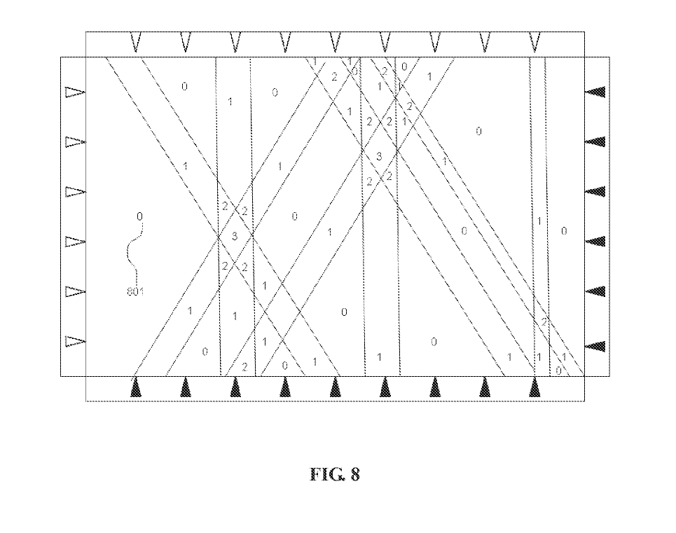

FIG. 7 is a schematic view of an updated brightness according to an axis scanning logical touch data group according to an embodiment of the present disclosure.

Referring to FIG. 7, a logical touch data group includes symbols 711, 712 and 713, in which the symbol 711 represents a starting position of a touch, the symbol 712 represents a width, and the parameter 713 represents a scanning axis angle, According to the symbols 711, 712 and 713, a parallelogram touch covering region 711-714-715-715 can be determined, and a brightness of the pixel points within the touch covering region is automatically added by 1. The symbols 701, 702 and 703 show updated brightness of different regions after the logical touch data is processed,

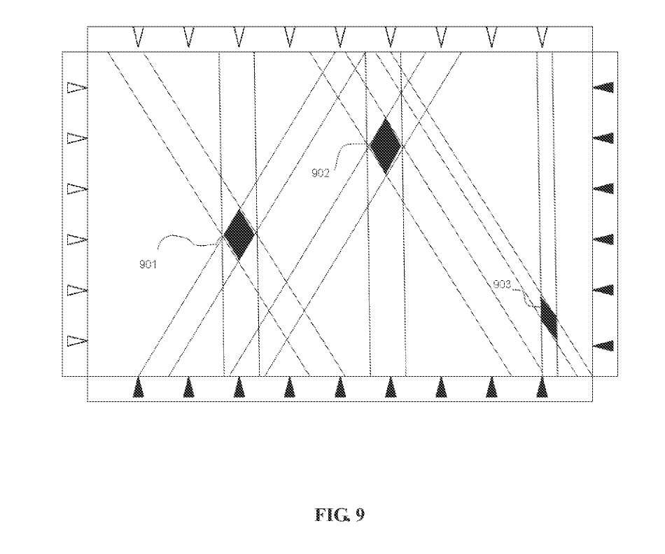

FIG. 8 is a schematic view of a final practical brightness map after all logical touch data groups are processed according to the embodiment in FIG. 4. As shown in FIG. 8, symbols such as 801 represent brightness in different regions.

FIG. 9 is a schematic view of touch regions obtained by comparing FIG. 5 with FIG. 8.

Each pixel point in FIG. 8 is compared with the corresponding pixel point in FIG. 5. If the theoretical brightness of a pixel point is equal to the practical brightness of the corresponding pixel point, the pixel point is in a touch region where a touch event happens. With the comparing method, three touch regions 901, 902 and 903 in FIG. 9 are obtained.

Comparing FIG. 4 with FIG. 9, it is found that envelopes of the touch regions obtained by the method disclosed herein are different from those of the real touch regions. However, with increasing of the number of the scanning axes, the envelopes of the touch regions obtained by the method disclosed herein approach closely to those of the real touch regions. It is should be noted that, as for a concave polygon touch region, a difference between the touch region obtained by the method disclosed herein and the real touch region is greater.

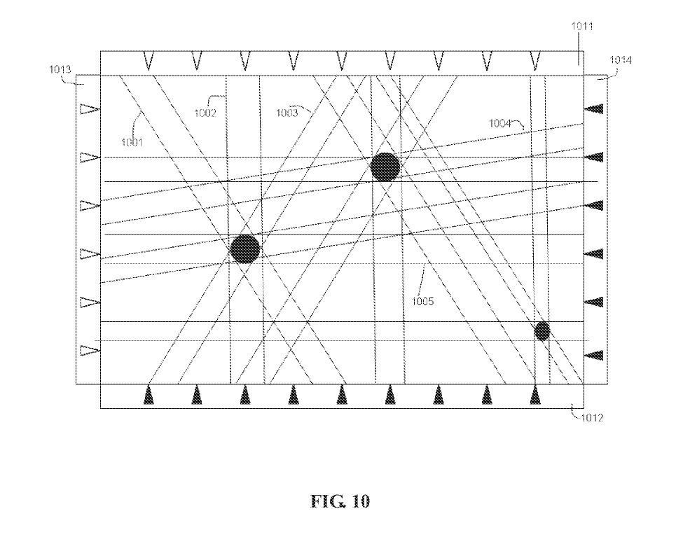

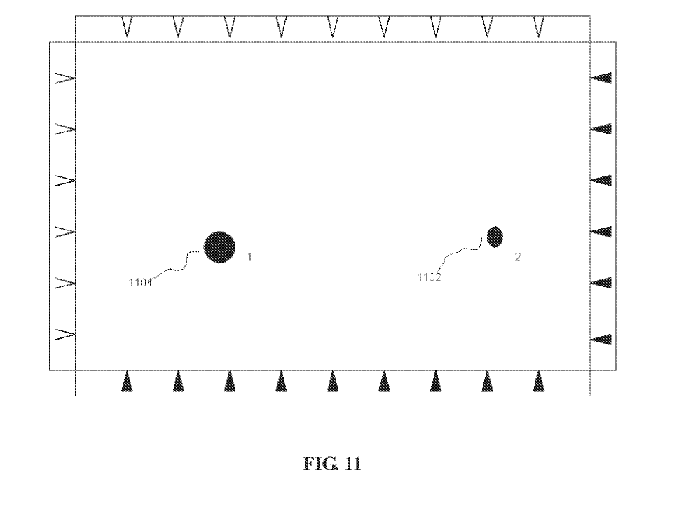

FIG. 10 is a schematic view of touch regions obtained by considering infrared transmission-reception unit pairs arranged along both a horizontal angle X and a vertical angle Y according to an embodiment of the present disclosure. Referring to FIG. 10, scanning axes 1001, 1002 and 1003 are three selected axes when the infrared transmission-reception pairs arranged along the horizontal angle X.

Scanning axes 1004 and 1005 are two selected axes when the infrared transmission-reception pairs arranged along the vertical angle Y. if both the horizontal angle X and the vertical angle Y are considered, the logical touch data of the scanning axes is processed by the same method in FIG. 4 and FIG. 9, however, the amount of the logical touch data needed to be processed increases because the number of the scanning axes increases.

In practical operation, as for a touch screen with a size less than 200 inch, generally, a higher accuracy and better recognition veracity can be achieved by arranging the infrared transmission-reception pairs along both the horizontal axis X and the vertical axis Y. However, in a case that a length of a touch screen along the Y axis is so large that data can not be identified due to a small signal to noise ratio, or in a case that the transmission-reception pairs can not be arranged along the Y axis, the infrared transmission-reception pairs arranged along the X axis can be utilized to process touch information of one touch point or multiple touch points. Similarly, in a case that a length of a touch screen along the X axis is too large, the infrared transmission reception pairs arranged along the Y axis can be utilized to process touch information of one touch point or multiple touch points.

Following describes how to transform from a touch region to a touch event information.

FIG. 11 is a schematic view of blob information after a frame data is processed according to an embodiment of the present disclosure.

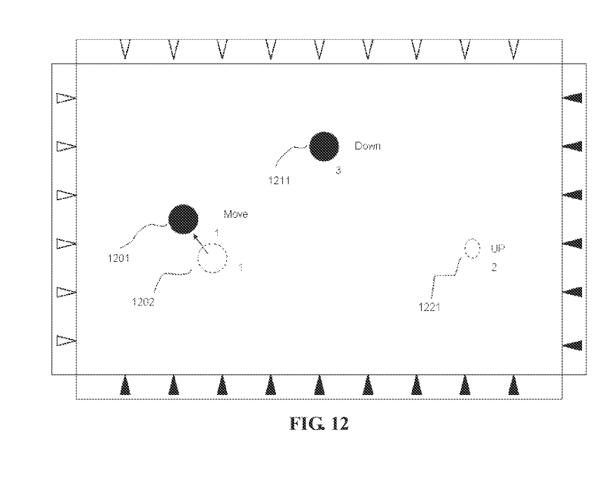

FIG. 12 is a schematic view illustrating a method for determining a touch event, a move event, an up event, and a down event according to an embodiment of the present disclosure. Referring to FIG. 12, touch regions 1202 and 1221 respectively are touch regions of a first and a second touch event in a previous frame. According to a tracking algorithm, a touch region 1201 is a touch region of the first touch event in the current frame, therefore, the first touch event is identified to be a “MOVE” event. There is no touch region information for a third event at the previous frame, therefore, a touch region 1211 corresponds to a “DOWN” event. There is no touch region information for the second event in the current frame, therefore, the second touch event is a “UP” event. Generally, the tracking algorithm calculates through distances, which is can be referred to related image processing knowledge.

Although the present invention has been disclosed as above with reference to preferred embodiments, it is not intended to limit the present invention. Those skilled in the art may modify and vary the embodiments without departing from the spirit and scope of the present invention. Accordingly the scope of the present invention shall be defined in the appended claim.

1. An infrared touch screen device, comprising:
infrared transmission units having greater transmission angle ranges and infrared reception units having greater reception angle ranges, adapted for performing axis scanning along various angles to obtain original axis scanning data, wherein the original axis scanning data are processed by removing environmental lights and normalization to generate logical touch data which is followed by processing the logical touch data to form a practical brightness map of current frame and comparing the practical brightness map with a theoretical brightness map to determine touch regions successively.

2. The infrared touch screen device according to claim 1, further comprising multiple sets of analog signal processing devices.

3. The infrared touch screen device according to claim 1, further comprising multiple analog digital converter devices.

4. The infrared touch screen device according to claim 1, wherein the infrared reception units are continually supplied with electricity, or supplied with electricity in groups.

5. A method for positioning multiple touch points on an infrared touch screen, comprising:
predetermining scanning axes and scanning angles corresponding to the scanning axes, and initializing hardware of an infrared touch screen device;
creating an image which has a same resolution in magnitude as that of a touch screen, and initializing brightness of each pixel point as 0;
successively performing axis scannings in different angles in a scanning period, obtaining logical touch data groups of the axes by data processing to the axis scanning data, such as substraction of environmental lights and normalization, wherein each logical touch data group includes a starting positions of an axis scanning region of an touch point and a width of axis scanning region of the touch point, and the logical touch data group has following formats:
a starting position 1, a width 1, a starting position 2, a width 2 . . . , a starting position N, a width N, N is a natural number;
or a starting position 1, an ending position 1, a starting position 2, an ending position 2 . . . , a starting position N, an ending position N; or other similar formats indicating these logical information, N is a natural number;
finding parallelogram axis scanning regions according to logical touch data groups (including the axis angles, starting positions, and widths) obtained in the step 3 in the image created in the step 2, and forming a practical brightness map after successively processing all logical touch data groups, wherein a logical touch information group corresponds to a parallelogram axis scanning region, and at each time after finding a parallelogram axis scanning region, brightness of pixel points in the parallelogram axis scanning region is increased by 1; calculating theoretical brightness of each pixel when is in touched state to create a theoretical brightness map; and
comparing the practical brightness map with theoretical brightness map to determine touch regions, wherein the region whose theoretical brightness is equal to it's practical brightness is a touch region where the touch event happens.

6. The method according to claim 5, further comprising: obtaining different blob information of the touch regions at different frames, and determining types of the touch events by combination a tracking algorithm with analyzing the blob information.

7. The method according to claim 5, wherein the infrared transmission units and infrared reception units are arranged along a length direction or a width direction of the touch screen in the infrared touch screen device.
